(19) United States
(12) Patent Application Publication
(10) Pub. No.: US 2008/0217509 A1
(43) Pub. Date: Sep. 11, 2008

(54) INCREASED COLOR DEPTH MODULATION USING FAST RESPONSE LIGHT SOURCES

(76) Inventor: William Thomas WEATHERFORD, San Mateo, CA (US)

Correspondence Address: PATTERSON & SHERIDAN, L.L.P., 3040 POST OAK BOULEVARD, SUITE 1500, HOUSTON, TX, 77056, US

(21) Appl. No.: 11/682,100

(22) Filed: Mar. 5, 2007

(51) Int. Cl. G01J 1/32

(52) U.S. Cl. 250/205

(57) ABSTRACT

Embodiments of the present invention generally relate to a display system and method of using one or more fast response light sources and one or more spatial light modulator devices to modulate light. More particularly, embodiments of the present invention relates to a display system and method of using one or more fast response light sources and one or more spatial light modulator devices to provide for improved light intensity resolution.

### BACKGROUND OF THE INVENTION

1. Field of the Invention

Embodiments of the present invention generally relate to spatial light modulator devices, and more particularly to a display system and method of using one or more fast response light sources and one or more spatial light modulator devices to modulate light.

2. Description of the Related Art

Spatial light modulator (SLM) devices have numerous applications in the areas of optical information processing, projection displays, video and graphics monitors, three-dimensional visual displays, holographic storage, microscopes, spectroscopes, medical imaging, and electrophotographic printing.

A micro-mirror device (MMD) is one example of a SLM device. An MMD display typically comprises an array of mirrors in which each mirror can be electronically controlled to assume two positions—an “on” state and an “off” state. Mirrors in an “on” state reflect incident light to a projection lens onto a screen to form an image. Mirrors in an “off” state reflect incident light to a beam dump and do not reflect incident light to the projection lens.

The brightness or intensity in an MMD display may be produced by controlling the time that a mirror spends in the on state and in the off state during an image frame. Pulse width modulation (PWM) is one technique to control the time each mirror spends in the on state during each frame time.

FIG. 1 is a bit-block representation of one example of a binary weighted PWM scheme in which the light intensity of a frame is controlled by splitting the frame into eight binary weighted time periods (B7-B0). The length of each block represents the amount of time the bit is asserted on an SLM, such as a mirror of an MMD display. The length of time period corresponding to block B0, also called the least significant bit (LSB), is set at a predetermined value. The duration of the time period corresponding to B1 or the next significant bit is twice as long as that corresponding to the LSB. The duration of the time period corresponding to B2 is twice as long as that corresponding to the B1 and so on and so forth. Thus, the length of the time period corresponding to B7 (also called the most significant bit (MSB)) is 128 times the time period of the LSB. This gives a total of 256 possible intensity steps from zero intensity or full dark (a mirror in an MMD display remains in the off state for the full frame time) to full intensity or full light (a mirror in an MMD display remains in the on state for the full frame time). U.S. Pat. No. 6,326,980 and U.S. Pat. No. 6,151,011 disclose other PWM schemes, the entirety of which is incorporated herein by reference.

MMD displays typically have a linear signal-to-light response while cathode ray tube (CRT) displays have a non-linear signal-to-light response—the phosphor-coated screen of CRT displays do not respond linearly with voltage. A function using a correction factor gamma is applied to compensate for CRT's non-linear signal-to-light response. Existing video signals typically are provided with gamma correction already applied to them. Therefore, MMD displays typically require that the gamma correction to be removed or reversed from the input signal before display to mimic the response of a CRT.

FIG. 2 is a graph of first 40 inputs of a theoretical gamma curve 20 and a modulated gamma curve 21 for an MMD display having 8 bits of output resolution. The MMD display theoretically has 256 inputs relating to 256 intensity levels. However, an MMD display having 8 bits of output resolution, the intensity changes in a step wise series 22a-d and results in poor light intensity resolution at low light intensity levels. At low light intensity levels, the step size is relatively large since the PWM scheme does not yield a completely proportional on/off cycle due to LSB time to control a mirror. These large step changes in intensity may be perceived by the human eye and results in a poor display. Other displays may have a similar problem, but it may be located in a different section of the gamma curve. For example, some LCD displays have step size issues located in the middle of the gamma curve.

Thus, there is a need for an improved spatial light modulator devices and method of operating the same to provide for improved light intensity resolution at low light intensity levels.

### SUMMARY OF THE INVENTION

Embodiments of the present invention generally relate to a display system and method of using one or more fast response light sources and one or more spatial light modulator devices to modulate light. More particularly, embodiments of the present invention relate to a display system and method of using one or more fast response light sources and one or more spatial light modulator devices to provide for improved light intensity resolution.

In one embodiment, a method of increasing the color depth comprises providing a light at full intensity from a fast response light source to a spatial light modulator device for a first time segment of a color field and providing a smaller unit of light energy from the fast response light source to the spatial light modulator device for a second time segment of the color field.

In one embodiment, a controller is adapted to control a micro mirror array and a fast response light source. The controller asserts a first set of bits on a mirror of the micro mirror array, controls the fast response light source to provide incident light to the mirror at full intensity during assertion of the first set of bits, asserts a second set of bits on the mirror, and controls the fast response light source to provide incident light to the mirror at smaller unit of light energy during assertion of the second set of bits.

In one embodiment, a display system comprises one or more spatial light modulator devices, one or more fast response light sources directed at the one or more spatial light modulator devices, and a controller coupled to the one or more fast response light sources to operate the one or more fast response light sources at a full unit of light energy mode and at a smaller unit of light energy mode.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a bit-block representation of one example of a binary weighted PWM scheme.

FIG. 2 is a graph of a theoretical gamma curve and a modulated gamma curve for an MMD display having 8 bits of output resolution.

FIG. 3 is a schematic diagram of one embodiment of an MMD display system including a fast response light source and a single micro mirror array.

FIG. 4 is a schematic diagram of one embodiment of an MMD display system including three fast response light sources and one micro mirror array.

FIG. 5 is a schematic diagram of one embodiment of an MMD display system including a fast response light source and three micro mirror arrays.

FIG. 6 is a schematic diagram of another embodiment of an MMD display system including three fast response light sources and three micro mirror arrays.

FIG. 7 is a time diagram representation of one embodiment of a video frame split into color fields in an MMD display system with a color filter wheel.

FIG. 8 is time diagram representation of one embodiment of a frame split into color fields in an MMD display without a color filter wheel.

FIG. 9 is a timing diagram conceptually illustrating how a frame is controlled in an MMD display in which there are separate micro mirror arrays for each color.

FIG. 10 is a chart of one example of a modulation sequence for controlling a color field and a fast response light source.

FIG. 11A is a time diagram of one example of providing a smaller unit of light energy from the fast response light source by pulsing the fast response light source off.

FIG. 11B is a time diagram of one example of providing a smaller unit of light energy from the fast response light source by reducing the intensity of the fast response light source.

FIG. 12 is a bit-block representation of one embodiment of a sub bit segment further divided into a plurality of sub bits.

FIG. 13 is a graph of one example of a theoretical gamma curve and a modulated gamma curve for an MMD display in which the light intensity is modulated in a sub-bit improving step size issues.

FIG. 14 is a chart of another embodiment of a modulation sequence for controlling a color field and a fast response light source.

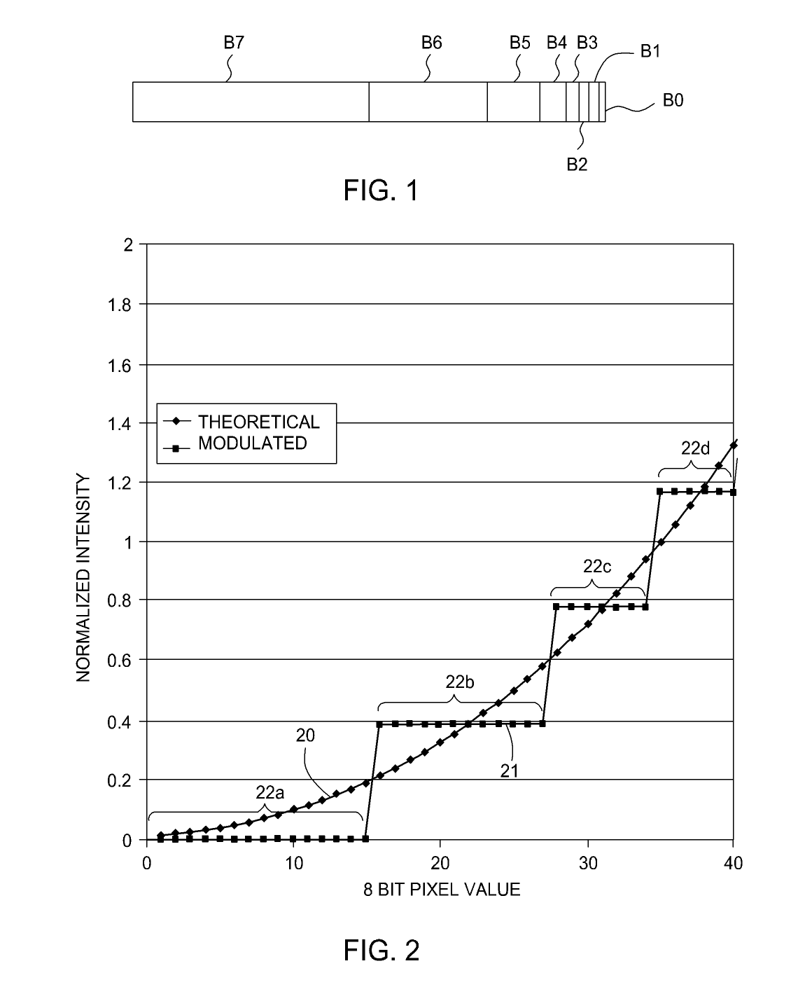

### DETAILED DESCRIPTION

As used herein, the term “fast response light sources” include lasers, light emitting diodes, ultra-high performance lamps, any other light source that has a fast response time to change the intensity of light. Any fast response light source that can change from full intensity to a lower intensity or from full intensity to off may be used to advantage of the present invention. Examples of suitable LED's are available from OSRAM located in München, Germany.

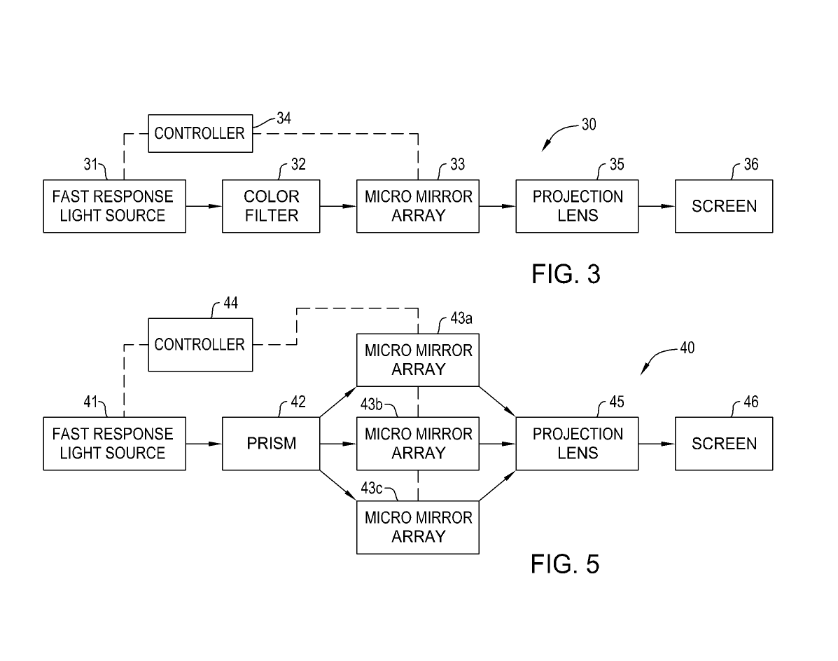

FIG. 3 is a schematic diagram of one embodiment of an MMD display system 30 including a fast response light source 31 and a single micro mirror array 33. The fast response light source 31 is arranged such that the beam from the fast response light source is directed through a spinning color filter wheel 32 having one or more red, green, and blue sections. The color filter wheel 32 may also have a white or clear section to increase the amount of white light displayed. Red, green, blue light, and white light, as the case may be, is shined onto the micro mirror array 33. One or more controllers 34 are coupled to the fast response light source 31, the color filter 32, and the micro mirror array 33 to synchronize the intensity of the light from the fast response light source 31 with the rate of speed of the spinning color filter wheel 32 and with the state of the micro mirror array 33. The micro mirror array 33 is arranged to deflect pixels of light away from or through a projection lens 35 onto a display screen 36.

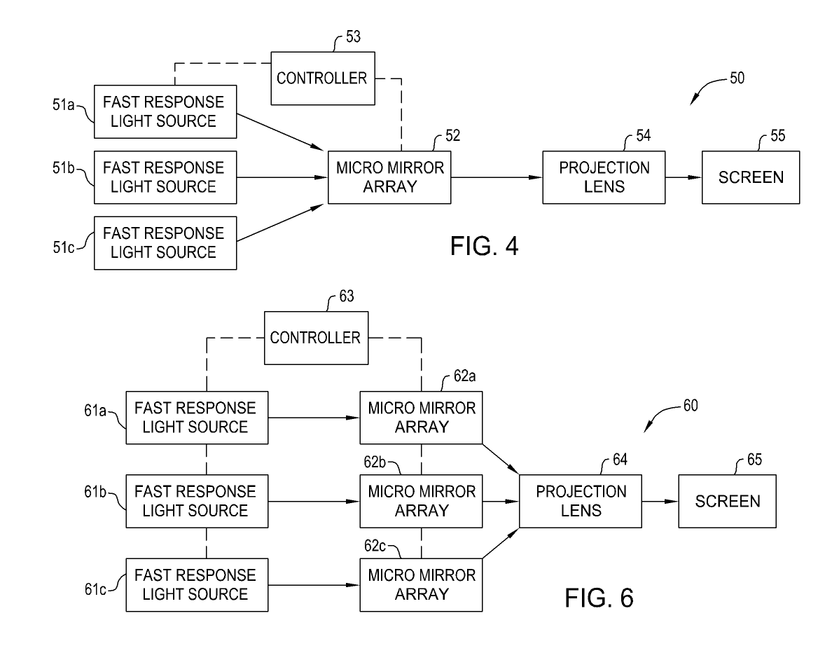

FIG. 4 is a schematic diagram of one embodiment of an MMD display system 50 including three fast response light source 51a, 51b, 51c and one micro mirror array 52. Fast response light source 51a, 51b, 51c respectively provides red light, green light, and blue light onto the micro mirror array 52. One or more controllers 53 are coupled to the fast response light sources 51a-c and the micro mirror array 52 to coordinate the intensity of the light from the fast response light sources 51a-c with the state of the micro mirror array 52. The micro mirror array 52 directs pixels of light away from or through a projection lens 54 onto a display screen 55.

FIG. 5 is a schematic diagram of one embodiment of an MMD display system 40 including a fast response light source 41 and three micro mirror arrays 43a, 43b, 43c. The fast response light source 41 is arranged such that the beam from the fast response light source is directed through a prism 42. In other embodiments, one or more mirrors and other optical systems may be used instead of a prism or in conjunction with a prism. The prism 42 divides the light into red, green, and blue light, which are directed to a corresponding micro mirror arrays 43a, 43b, 43c. One or more controllers 44 are coupled to the fast response light source 41 and the micro mirror arrays 43a-c to coordinate the intensity of the light from the fast response light source 41 with the state of the micro mirror arrays 43. The micro mirror arrays 43a-c are arranged to deflect pixels of light away from or through a projection lens 45 onto a display screen 46.

FIG. 6 is a schematic diagram of another embodiment of an MMD display system 60 including three fast response light sources 61a-61c and three micro mirror arrays 62a-c. Fast response light sources 61a-c provides red, green, and blue light respectively onto micro mirror array 62a-c. One or more controllers 63 are coupled to the fast response light sources 61a-c and the micro mirror arrays 62a-c to coordinate the intensity of the light from the fast response light sources 61a-c with the state of the micro mirror arrays 62a-c. The micro mirror arrays 62a-c directs pixels of light away from or through a projection lens 64 onto a display screen 65.

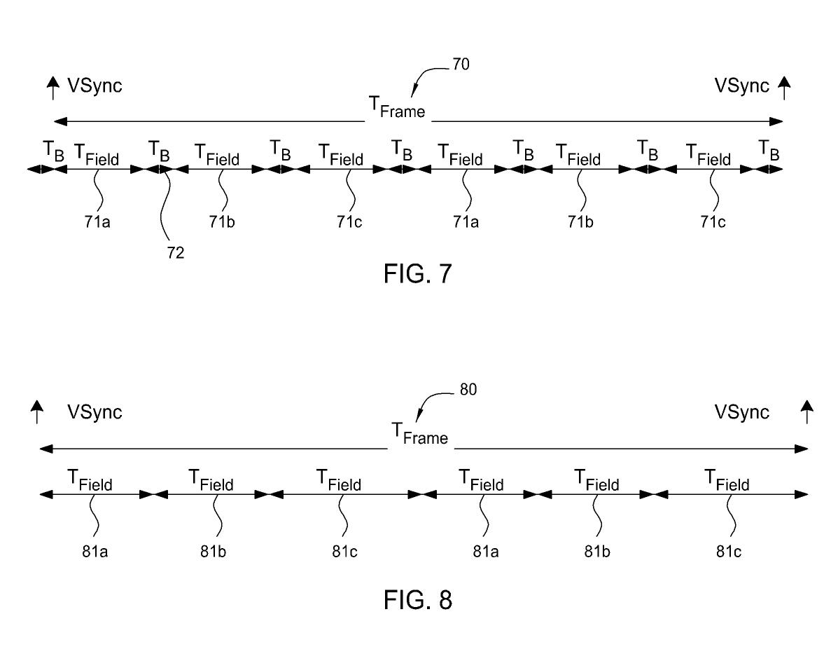

FIG. 7 is a time diagram representation of one embodiment of a frame 70 split into color fields 71a-c in an MMD display system with a color filter wheel, such as display system shown in FIG. 3. For a 3 segment color filter wheel rotating at two times the frame rate, the frame would be split into 6 color fields. In other words, two red color fields 71a, two green color fields 71b, and two blue color fields 71c. A blanking interval 72 may be disposed between each color field to prevent color abnormalities as the color wheel spoke traverses through the illumination beam. In other embodiments, a frame may be split into any number or order of color fields based on the number of segments of the color filter wheel and the rotational speed of the color filter wheel.

FIG. 8 is a time diagram representation of one embodiment of a frame 80 split into color fields 81a-c in an MMD display without a color filter wheel, such as the displays shown in FIG. 4. As shown in FIG. 8, the frame can be split into 6 color fields—two red color fields 81a, two green color fields 82b, and two blue color fields 83c. Note that there is no blanking interval in this case since there is no color filter wheel employed. In other embodiments, the frame can be split into any number or order of color fields and the color fields may be interleaved.

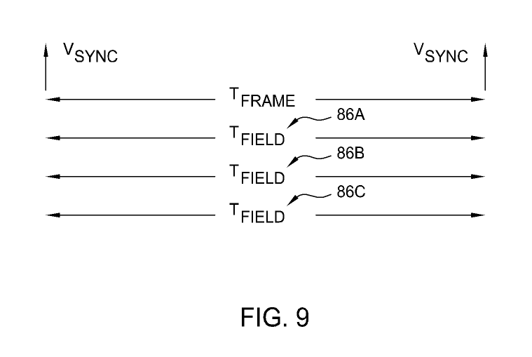

FIG. 9 is a timing diagram conceptually illustrating how a frame is controlled in an MMD display in which there are separate micro mirror arrays for each color, such as the display systems of FIGS. 5 and 6. Since there are separate micro mirror arrays for each color, the frame does not need to be split into separate color fields. Each color field, such as red color field 86a, green color field 86b, and blue color field 86c can be the same duration of the frame.

For illustration purposes only, one approach to controlling a display system is divide each micro mirror array, such as the micro mirror arrays of FIGS. 3-6, into 32 regions. For example, each region may include 12 lines of 512 pixels. Other configurations are possible with each micro mirror array being controlled by any number of sections, each section may be further divided into any number of regions, each region may include any number of lines, and each line may include any number of pixels.

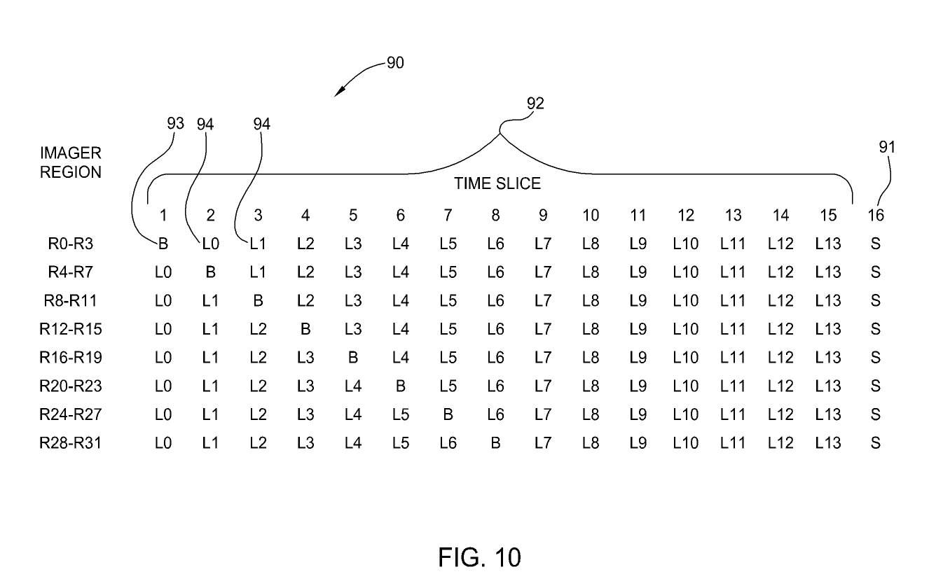

FIG. 10 is a chart of one example of a modulation sequence 90 for controlling a color field of a micro mirror array section having 32 image regions, such as one of the color fields in FIGS. 7-9, and for controlling a fast response light source. As shown, the color field is split into 16 time slices and the 32 regions are controlled by 8 groups. The color field may be modulated as one six-binary weighted segment, fourteen linear bit segments, and one sub bit segment 91 divided into any number of sub bit times. In other embodiments, the color field may be split into any plurality of time slices, the regions may be controlled in any number of groups, and the time slices may be modulated in any combination of binary weighted segments, linear segments, and sub bit segments. In sub bit segment 91, a smaller unit of light energy is provided from the fast response light source. Adding a sub bit segment in which the fast response light source provides a smaller unit of light energy increases the number of modulation units and thus improves the color depth since the step change from one intensity to the next intensity is reduced. A sub-bit segment, such as one or more T_{sub-bit}'s, can be any time unit as long as the whole micro mirror array has the state of the appropriate sub-bit. Therefore, in general, the minimum duration of T_{sub-bit} is the time to write the micro mirror array.

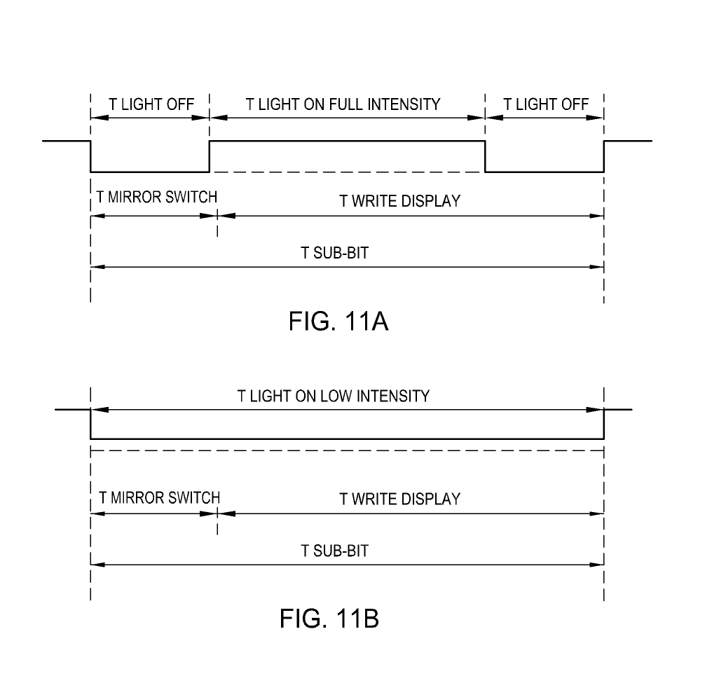

In one embodiment, this smaller unit of light energy from the fast response light source is provided by pulsing the fast response light source off. For example, as shown in FIG. 11A, the light is pulsed off for one-half of the duration of the sub bit and pulsed on for one-half of the duration of the sub bit at full intensity (I). Thus, the unit of light energy that can be controlled is ½T_{sub-bit}×I. It is understood that the fast response light source may be pulsed on and off for any suitable duration and any number of pulses.

In another embodiment, as shown in FIG. 11B, this smaller unit of light energy from the fast response light source is provided by reducing the intensity of the light source to a lower intensity (i.e., any fraction of the light at full intensity (I)) during the duration of the sub bit. For example, the light intensity for the duration of the sub bit may be provided at half full intensity ½I. Thus, the unit of light energy that can be controlled is ½T_{sub-bit}×I. It is understood that the intensity of the fast response light source may be reduced to any suitable intensity. It is understood that in another embodiment, this smaller unit of light energy from the fast response light source may be provided by a combination of pulsing on and off the light and by reducing the intensity of the light source. For example, the light from the fast response light source may be pulsed off for one-half the duration of the sub bit and pulsed on for one-half the duration of the sub bit at a light intensity of ½ full intensity (½I). Thus, the unit of light energy that can be controlled is ¼T_{sub-bit}×I.

Thus, one may provide any desired smaller unit of light energy by pulsing the fast response light source off and on and/or by reducing the intensity of the fast response light source. It is understood that in a real fast response light source, the rise and fall times for the light source will be non-zero. Thus, the energy output during a sub bit would be equal to the total energy of the light source during that time (i.e., the integral of the light intensity). Therefore, in the above two examples as described in conjunction with FIG. 11A and FIG. 11B, the unit of light energy may not be exactly ½T_{sub-bit}×I.

Referring back to the example of FIG. 10, during the other time slices 92, the light from the fast response light source is operated at full intensity or full unit of light energy mode. The other times slices 92 may include at least one binary weighted segment 93. The other times slices may include a plurality of linear bit segments 94, each have an equal duration of time. The binary weighted segment 93 may be arranged in any order between the groups of regions. As shown, the binary weighted segment is offset from groups to groups of regions in order to reduce the controller bandwidth. The bits within the binary weighted segment may also be arranged in any order and the bits within a binary weighted segment may be arranged in the same or in a different order within a grouping of image regions.

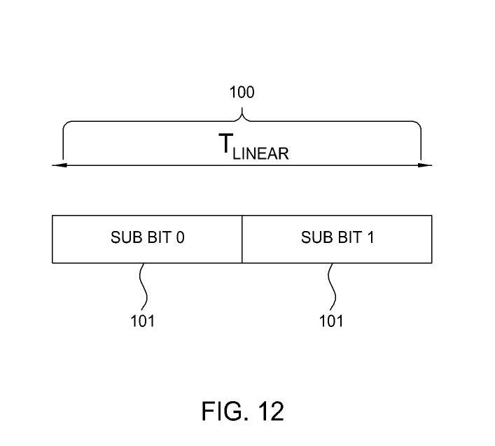

In one certain embodiment, the sub bit segment 91 is ordered at the same time slice since each of the regions share the same fast response light source. In certain embodiments, the sub bit segment 91 may be divided into a plurality of sub bit times. FIG. 12 is a bit-block representation of one embodiment of a sub bit segment 100 divided into two sub bit times 101.

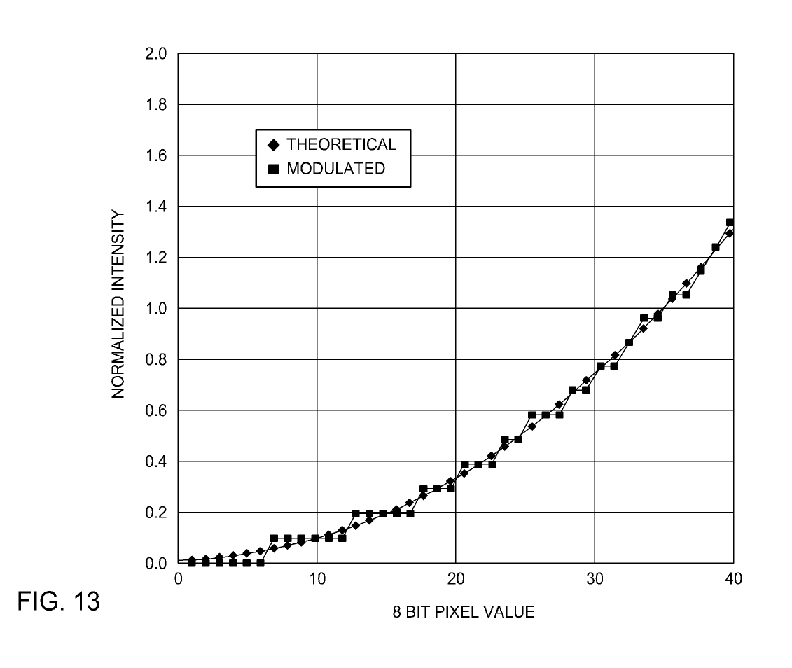

For example, the modulation sequence 90 as shown in FIG. 10 may be modulated as one six-binary weighted segment, fourteen linear bit segments, and one sub bit segment divided into two sub bits times. For a time slice of a six-binary weighted segment equaling the period of a time slice of a linear bit segment, if the luminance of the least significant bit of the six-binary weighted segment is valued at Y, the luminance of a linear bit would be 63Y. In one embodiment, the intensity of the light source may be controlled to a smaller unit of light energy, such as to an intensity of (⅔)*Y by pulsing the light on and off and/or by reducing the intensity during the sub bit segment. Therefore, for a sub bit segment controlled by two sub bits times, each sub bit time would have an intensity of ⅓*Y. The resulting sequence would have 2,835 (63×15×3) unique intensities from 63 LSB time units from the n-binary weighted time period (2^{N}−1), from the 15 full intensity units from m linear bit segments (m+1), and the 3 sub intensity units from the m′ sub bit times (m′+1). In comparison, for a modulation sequence with 6-binary weighted time period and with 15 linear segments, there would be 1008 unique intensities (63×16). By controlling a smaller unit of light energy during the sub bit segment, the color depth is increased by over 2.8 times with a less than 1/16 reduction in overall maximum intensity output for the entire color field. The color depth or gray scale for each color may be increased with a reasonable decreased in overall maximum intensity output of the color field. With an increase of unique intensities at low light intensity levels, the step size and the number of inputs corresponding to a step are reduced for the gamma curve. For comparison purposes to FIG. 2, FIG. 13 is a graph of one example of a theoretical gamma curve and a modulated gamma curve for an MMD display in which the light intensity is modulated in a sub-bit improving step size issues.

The fast response light source has a response time faster than the mirror switch time. One typical mirror switch time is about 5 microseconds or less. In certain embodiments, the fast response light source has a response time of 3 microseconds or less. Currently available arc lamps do not have the adequate response time to change intensity within a mirror switch time.

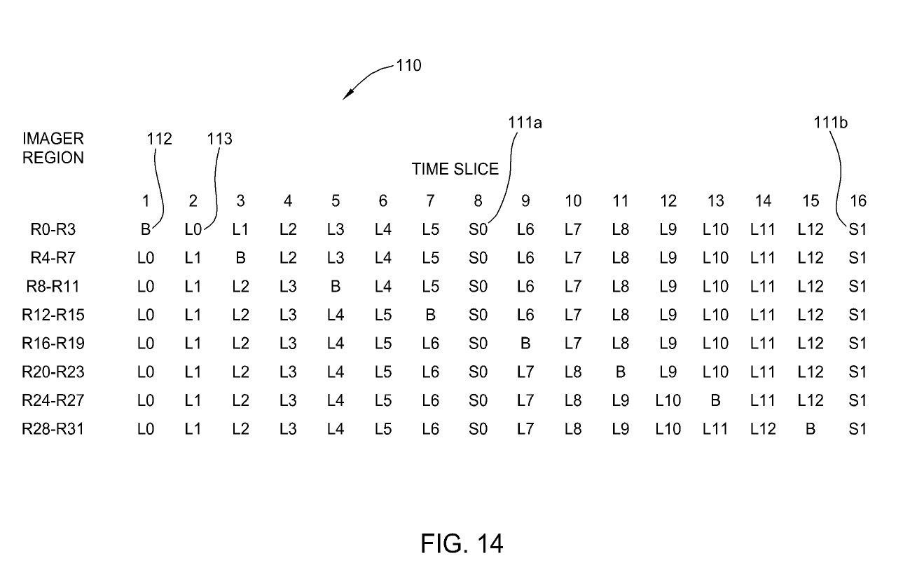

In other embodiments, the modulation sequence for controlling a color field may include a plurality of sub bit segments. For example, FIG. 14 is a chart of one embodiment of a modulation sequence 110 having two sub bit segments 111a-b, one binary weight time period 112, and thirteen linear bit segments 113.

While the foregoing is directed to embodiments of the present invention, other and further embodiments of the invention may be devised without departing from the basic scope thereof, and the scope thereof is determined by the claims that follow. For example, embodiments of the present invention have been described herein in conjunction one the aligned modulation sequences of FIG. 10 and FIG. 14. Embodiments of the present invention may also be used to advantage in other modulation sequences. For instance, embodiments of the present invention may be used in conjunction with the bit splitting method as described in U.S. Pat. No. 5,777,589, assigned to Texas Instruments. In another example, embodiments of the present invention have been described herein in conjunction with a SLM comprising a micro mirror array. Embodiments of the present invention may also be used to advantage in other SLM devices, such as in LCD devices.

1. A method of increasing the color depth, comprising:
providing a light at full intensity from a fast response light source to a spatial light modulator device for a first time segment of a color field; and
providing a smaller unit of light energy from the fast response light source to the spatial light modulator device for a second time segment of the color field.

2. The method of claim 1, wherein the smaller unit of light energy is provided by pulsing the fast response light source off.

3. The method of claim 1, wherein the smaller unit of light energy is provided by reducing the intensity of the fast response light source.

4. The method of claim 1, wherein the second time segment of the color field comprises a plurality of sub bits.

5. The method of claim 1, wherein the first time segment comprises a binary weighted time segment.

6. The method of claim 4, wherein the first time segment further comprises a plurality of linear bit segments.

7. The method of claim 1, wherein the spatial light modulator device comprises a region of a micro mirror array.

8. The method of claim 1, wherein the response time of the one or more fast response light sources is about 3 microseconds or less.

9. A controller adapted to control a micro mirror array and a fast response light source, the controller performing a method comprising:
asserting a first set of bits on a mirror of the micro mirror array;
controlling the fast response light source to provide incident light to the mirror at full intensity during assertion of the first set of bits;
asserting a second set of bits on the mirror; and
controlling the fast response light source to provide incident light to the mirror at smaller unit of light energy during assertion of the second set of bits.

10. The method of claim 9, wherein the smaller unit of light energy is provided by pulsing the fast response light source off.

11. The method of claim 9, wherein the smaller unit of light energy is provided by reducing the intensity of the fast response light source.

12. The method of claim 9, wherein the second set of bits comprise at least two bits.

13. The method of claim 9, wherein the first set of bits comprise a binary weighted group of bits.

14. The method of claim 9, wherein the first set of bits further comprise a plurality of linear bits.

15. The method of claim 9, wherein the controller is adapted to control a color filter wheel, the method further comprising signaling the color wheel to synchronize a color during assertion of the first set of bits and assertion of the second set of bits.

16. A display system, comprising:
one or more spatial light modulator devices;
one or more fast response light sources directed at the one or more spatial light modulator devices; and
a controller coupled to the one or more fast response light sources to operate the one or more fast response light sources at a full unit of light energy mode and at a smaller unit of light energy mode.

17. The display system of claim 16, wherein the one or more spatial light modulator devices comprise one or more micro mirror arrays.

18. The display system of claim 16, wherein the one or more fast response light sources comprises one or more lasers.

19. The display system of claim 16, wherein the smaller unit of light energy mode is provided by pulsing the fast response light source off.

20. The display system of claim 16, wherein the smaller unit of light energy mode is provided by reducing the intensity of the fast response light source.
